(19) United States
(12) Patent Application Publication
(10) Pub. No.: US 2025/0281786 A1
(43) Pub. Date: Sep. 11, 2025

(54) SUGAR AND SALT COMPOSITION TO SUPPRESS LITHIUM FIRES

(71) Applicant: Tyco Fire Products LP, Cranston, RI (US)

(72) Inventors: JoAnna Marie Monfils, Peshtigo, WI (US); Blake Bomann, Greenville, WI (US)

(73) Assignee: Tyco Fire Products LP, Cranston, RI (US)

(21) Appl. No.: 18/859,753

(22) PCT Filed: May 19, 2023
(86) PCT No.: PCT/US2023/022828

§ 371 Date: Oct. 24, 2024

Related U.S. Application Data
(60) Provisional application No. 63/348,228, filed on Jun. 2, 2022.

(51) Int. Cl. A62D 1/00

(52) U.S. Cl. CPC A62D 1/0035; A62D 1/0064

(57) ABSTRACT

A firefighting composition includes a sugar component and a salt component. the salt component including potassium formate. potassium formate hydrate. potassium acetate, magnesium sulfate, ammonium sulfate, sodium chloride, sodium sulfate, ammonium chloride. or a mixture of any two or more thereof.

### CROSS-REFERENCE TO RELATED APPLICATIONS

This application claims the benefit of priority to U.S. Provisional Patent Application No. 63/348,228, filed on Jun. 2, 2022, the contents of which are incorporated herein by reference in their entirety.

### TECHNOLOGY

The present technology is generally related to firefighting compositions for fires and thermal runaway events. Specifically, the technology is related to compositions including a sugar and a salt for controlling fires in lithium-ion or sodium-ion battery applications.

### SUMMARY

In one aspect, a firefighting composition includes a sugar component; and a salt component including potassium formate, potassium formate hydrate, potassium acetate, magnesium sulfate, ammonium sulfate, sodium chloride, sodium sulfate, ammonium chloride, or a mixture of any two or more thereof.

In some embodiments, the sugar component comprises a monosaccharide sugar, a disaccharide sugar, or a sugar alcohol. In some embodiments, the sugar component comprises high fructose corn syrup, glucose, sucrose, or a mixture of any two or more thereof. In some embodiments, the sugar component comprises a carbonized or caramelized sugar. In some embodiments, the firefighting composition further comprises water.

In some embodiments, the firefighting composition includes from about 10 to about 90 wt % of the sugar component and from about 90 wt % to about 10 wt % of the salt component. In some embodiments, the firefighting composition includes from about 30 to about 70 wt % of the sugar component and from about 70 wt % to about 30 wt % of the salt component. In some embodiments, the firefighting composition includes about 50 wt % of the sugar component and about 50 wt % of the salt component.

In some embodiments, the salt component comprises potassium formate hydrate or potassium formate.

In another aspect, a method of fighting a fire includes applying a firefighting composition including a sugar component and a salt component to the fire. In some embodiments, the salt component includes potassium formate, potassium formate hydrate, potassium acetate, magnesium sulfate, ammonium sulfate, sodium chloride, sodium sulfate, ammonium chloride, or a mixture of any two or more thereof. In some embodiments, the firefighting composition further comprises water. In some embodiments, the fire is a lithium-ion battery fire or a sodium-ion battery fire.

In another aspect, a method of controlling a thermal runaway event associated with a lithium-ion or sodium-ion battery includes applying a firefighting composition including a sugar component and a salt component to a battery experiencing a thermal runaway event. In some embodiments, the salt component includes potassium formate, potassium formate hydrate, potassium acetate, magnesium sulfate, ammonium sulfate, sodium chloride, sodium sulfate, ammonium chloride, or a mixture of any two or more thereof. In some embodiments, the firefighting composition further comprises water.

### DETAILED DESCRIPTION

As used herein, “about” will be understood by persons of ordinary skill in the art and will vary to some extent depending upon the context in which it is used. If there are uses of the term which are not clear to persons of ordinary skill in the art, given the context in which it is used, “about” will mean up to plus or minus 10% of the particular term.

The use of the terms “a” and “and” and “the” and similar referents in the context of describing the elements (especially in the context of the following claims) are to be construed to cover both the singular and the plural, unless otherwise indicated herein or clearly contradicted by context. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or illustrative language (e.g., “such as”) provided herein, is intended merely to better illuminate the embodiments and does not pose a limitation on the scope of the claims unless otherwise stated. No language in the specification should be construed as indicating any non-claimed element as essential.

For fighting various types of high temperature fires, such as lithium-ion or sodium ion battery fires, agents are needed to provide thermal cooling and viscosity effects to control the fires and/or control thermal runaway events. This is particularly the case for controlling or suppressing fires associated with batteries.

In one aspect, a firefighting composition includes a sugar component and a salt component. In some embodiments, the salt may be potassium formate (or potassium formate hydrate), potassium acetate, magnesium sulfate, ammonium sulfate, sodium chloride, sodium sulfate, ammonium chloride, or a mixture of any two or more thereof. In some embodiments, the salt may be potassium formate (or potassium formate hydrate). In some embodiments, the firefighting composition further comprises water.

Saccharides for use in the present firefighting compositions are generally simple monosaccharide sugars and may include other carbohydrates, such as common sugar (sucrose/dextrose) derived from sugar cane or sugar beets. Sucrose is a disaccharide composed from the basic, simple sugar molecules glucose and fructose. Mixtures where the majority of the sucrose has been broken down into its monosaccharide components, glucose and fructose (e.g., invert sugar), are suitable for use in the present concentrates. Sucrose is readily available in view of its world production from cane and sugar beet on the order of millions of tons per annum. Those skilled in the art will also be aware that other commercially available simple monosaccharides and related sugar alcohols can be utilized in the present firefighting compositions.

In some embodiments, the sugar component may include a monosaccharide sugar, a disaccharide sugar, or a sugar alcohol. In some embodiments, the sugar component may include fructose, glucose, galactose, xylose, mannose, sucrose, lactose, maltose, an oligosaccharide, or a mixture of any two or more thereof. In some embodiments, the sugar alcohol may include a four carbon sugar alcohol, such as erythritol, a five carbon alditol, such as xylitol, a six carbon alditol, such as mannitol and/or sorbitol, and other sugar alcohols, such as isomalt. In some embodiments, the monosaccharide may be high fructose corn syrup. In some embodiments, the high fructose corn syrup may additionally contain glucose and/or oligosaccharides. The sugar component may also be a carbonized or caramelized sugar. For example, such carbonized or caramelized sugars may include, but are not limited to, brown sugar or molasses.

In the compositions, and without being bound by theory, it is believed that the salt component will act to control the battery hazard and functionally discharge the hazard through electrical conductivity, while the sugar component offers beneficial surface association and viscosity allowing the maximization of agent effectiveness.

In some embodiments, the firefighting composition comprises from about 10 to about 90 wt % of the sugar component and from about 90 wt % to about 10 wt % of the salt component. This may include where the firefighting composition comprises from about 30 to about 70 wt % of the sugar component and from about 70 wt % to about 30 wt % of the salt component; or about 50 wt % of the sugar component and about 50 wt % of the salt component.

In some embodiments, the firefighting composition further includes a surfactant component. The surfactant component may be an anionic surfactant, a zwitterionic surfactant, a nonionic surfactant, or a combination of two or more thereof.

In some embodiments, the anionic surfactant includes an alkyl sulfate surfactant, an alkyl sulfonate surfactant, alkyl ether sulfate surfactant, an alkyl ether sulfonate surfactant, or a combination of two or more thereof. In some embodiments, the anionic surfactant may include an alkyl sulfate surfactant and/or an alkyl sulfonate surfactant. In some embodiments, the alkyl sulfate salt surfactant includes include a C₈₋₁₂-alkyl sulfate salt. Non-limiting examples of the C₈₋₁₂-alkyl sulfate salt include a dodecyl sulfate salt, a decyl sulfate salt, an octyl sulfate salt, or a combination of any two or more thereof. In some embodiments, the alkyl sulfate salt includes an alkyl sulfate sodium salt, such as a sodium decyl sulfate, sodium octyl sulfate, or a combination thereof. In some embodiments, the alkyl sulfate salt includes an alkyl sulfate ammonium salt, such as an ammonium decyl sulfate, ammonium octyl sulfate, ammonium lauryl sulfate, or a combination thereof. In some embodiments, the anionic surfactant includes a C₈₋₁₄-alkyl sulfate salt and/or a C₈₋₁₄-alkyl sulfonate salt. In some embodiments, the firefighting composition further includes an anionic surfactant, which comprises one or more surfactants selected from C₈₋₁₂-alkyl sulfate salts and/or a C₈₋₁₂-alkyl sulfonate salts. As a non-limiting example, one or more of octyl sulfate salts, decyl sulfate salts, dodecyl sulfate salts and tetradecyl sulfate salts may be used as anionic surfactants in the present firefighting compositions. The anionic surfactant may be a sodium, potassium and/or ammonium salt.

In some embodiments, the zwitterionic surfactant includes an alkylamidoalkyl betaine surfactant, an alkyl betaine surfactant, an alkyl sulfobetaine surfactant, an alkylamidoalkylene hydroxysultaine surfactant, such as an alkylamidopropyl hydroxysultaine surfactant, or a combination of two or more thereof. As a non-limiting example, the firefighting composition further includes a zwitterionic surfactant, which comprises one or more of a C₈₋₁₈-alkylamidopropyl hydroxysultaine surfactant, a C₈₋₁₈-alkylamidopropyl betaine surfactant, a C₈₋₁₈-alkyl sulfobetaine surfactant, a C₈₋₁₈-alkyl betaine surfactant, or a combination of two or more thereof. Non-limiting examples of the alkylamidoalkylene hydroxysultaine surfactant include a C₈₋₁₈-alkylamidopropyl hydroxysultaine surfactant, such as a cocamidopropyl hydroxysultaine surfactant, which includes a laurylamidopropyl hydroxysultaine and a myristylamidopropyl hydroxysultaine. Non-limiting examples of the alkylamidoalkyl betaine surfactant include a C₈₋₁₈-alkylamidoalkyl betaine surfactant, such as a cocamidopropyl betaine, a tallowamidopropyl betaine, a laurylamidopropyl betaine or a myristylamidopropyl betaine. In some embodiments, the zwitterionic surfactant includes a C₈₋₁₄-alkylamidopropyl hydroxysultaine, such as a cocamidopropyl hydroxysultaine. In some embodiments, the zwitterionic surfactant includes laurylamidopropyl hydroxysultaine and/or myristylamidopropyl hydroxysultaine.

In some embodiments, the nonionic surfactant includes an aliphatic alcohol and/or an aliphatic alcohol ethoxylate. As a non-limiting example, the firefighting composition may include an aliphatic alcohol-based nonionic surfactant including an aliphatic alcohol having 8 to 14 carbon atoms and/or an aliphatic alcohol ethoxylate having 10 to 16 carbon atoms in its alcohol portion. The aliphatic alcohol ethoxylate may has an average degree of polymerization (i.e., the average number of ethylene oxide units) of about 0.7-2.0 and often of no more than about 1.5, no more than about 1.2, or no more than about 1.0. Aliphatic alcohols, which include a linear C₈₋₁₄-aliphatic alcohol, such as a C₈₋₁₄-fatty alcohol, may be used as a nonionic surfactant in the present firefighting compositions. Non-limiting examples of such alcohols include one or more of octyl alcohol, decyl alcohol, lauryl alcohol and myristyl alcohol. The firefighting composition may include an aliphatic alcohol ethoxylate having an average of no more than about 2 ethylene oxide units. In some embodiments, the aliphatic alcohol portion of such ethoxylates has about 10 to 16 carbon atoms. Non-limiting examples include decyl alcohol ethoxylates, lauryl alcohol ethoxylates and/or myristyl alcohol ethoxylates. In some embodiments, the alcohol ethoxylates have an average of no more than about 2 ethylene oxide units, no more than about 1.5 ethylene oxide units, no more than about 1.2 ethylene oxide units and, in some instances, no more than about 1 ethylene oxide units. In some embodiments, the aliphatic alcohol ethoxylate comprises an ethoxylate of a linear C₈₋₁₄-aliphatic alcohol having no more than about 1.2 ethylene oxide units.

In some embodiments, the firefighting composition further comprises an organic solvent. In some embodiments, the organic solvent comprises a glycol, a glycol ether, glycerol, a water-soluble polyethylene glycol, or a combination of two or more thereof. Examples of organic solvents include, but are not limited to, diethylene glycol n-butyl ether, dipropylene glycol n-propyl ether, hexylene glycol, ethylene glycol, propylene glycol, diethylene glycol, dipropylene glycol, tripropylene glycol, dipropylene glycol monobutyl ether, dipropylene glycol monomethyl ether, diethylene glycol monobutyl ether (“butyl carbitol”), ethylene glycol monobutyl ether, tripropylene glycol monomethyl ether, dipropylene glycol monoethyl ether, glycerol, or a mixtures of two or more thereof. In some embodiments, the organic solvent includes a mixture of an alkylene glycol and a glycol ether, such as a glycol butyl ether. In some embodiments, the organic solvent includes an alkylene glycol ether, such as ethylene glycol monoalkyl ether, propylene glycol monoalkyl ether, dipropylene glycol monoalkyl ether, diethylene glycol monoalkyl ether (e.g., butyl carbitol), or a combination of two or more thereof. In some embodiments, the organic solvent includes an alkylene glycol, such as ethylene glycol, propylene glycol, dipropylene glycol and/or diethylene glycol. In some embodiments, the organic solvent may include a mixture of butyl carbitol and a glycol ether, such as ethylene glycol and/or propylene glycol. As a non-limiting example, the organic solvent may include ethylene glycol and butyl carbitol. In some embodiments, the organic solvent includes propylene glycol and butyl carbitol.

In some embodiments, the firefighting composition further includes a thickener, such as a polysaccharide thickener. In some embodiments, the thickener comprises agar, sodium alginate, carrageenan, gum arabic, gum guaicum, neem gum, pistacia lentiscus, gum chatti, caranna, galactomannan, gum tragacanth, karaya gum, guar gum, welan gum, rhamsam gum, locust bean gum, beta-glucan, cellulose, methylcellulose, chicle gum, kino gum, dammar gum, glucomannan, succinoglycan, mastic gum, spruce gum, tara gum, gellan gum, acacia gum, cassia gum, diutan gum, fenugreek gum, ghatti gum, hydroxyethylcellulose, hydroxypropylmethylcellulose, karaya gum, konjac gum, pectin, propylene glycol alginate, or a mixture of any two or more thereof. In some embodiments, the thickener comprises xanthan gum, diutan gum, rhamsan gum, welan gum, gellan gum, guar gum, konjac gum, tara gum, succinoglycan, methylcellulose, or a combination of two or more thereof.

In some embodiments, the firefighting composition further includes a mixture of xanthan gum and one or more of diutan gum, rhamsan gum, welan gum, gellan gum, guar gum, konjac gum, tara gum, succinoglycan, and methylcellulose. In some embodiments, the firefighting composition further includes a mixture of xanthan gum and one or more of diutan gum, rhamsan gum, welan gum, succinoglycan, and gellan gum as the polysaccharide thickener. In some embodiments, the firefighting composition further includes a mixture of xanthan gum and diutan gum and/or rhamsan gum. In some embodiments, the firefighting composition further includes a mixture of xanthan gum and succinoglycan. In some embodiments, the firefighting composition further includes a mixture of xanthan gum and welan gum. In some embodiments, the firefighting composition further includes welan gum.

In some embodiments, the firefighting composition further includes water. In some embodiments, the water is water from a municipal water source (e.g., tap water). In some embodiments, the water is a purified water, such as purified water that meets the standards set forth in the United States Pharmacopeia, which is incorporated by reference herein in relevant part.

In some embodiments, the firefighting composition further includes one or more chelators or sequestering buffers. Illustrative and non-limiting chelators and sequestering buffers include agents that sequester and chelate metal ions, including polyamminopolycarboxylic acids, ethylenediaminetetraacetic acid, citric acid, tartaric acid, nitrilotriacetic acid, hydroxyethylethylenediaminetriacetic acid and salts thereof. Illustrative buffers include Sorensen's phosphate or Mcllvaine's citrate buffers.

In some embodiments, the firefighting composition further includes one or more corrosion inhibitors. Illustrative and non-limiting corrosion inhibitors includes ortho-phenylphenol, tolyltriazole, and phosphate ester acids. In some embodiments, the corrosion inhibitor is tolyltriazole.

In some embodiments, the firefighting composition further includes a metallic salt, such as a metallic salt, which includes a multi-valent cation. Non-limiting examples include a cation selected from the group consisting of aluminum, calcium, copper, iron, magnesium, potassium, and calcium cations. The counteranion may be a sulfate and/or phosphate anion. In one embodiment, the metallic salt may include magnesium sulfate

In some embodiments, the firefighting composition further includes a reducing agent. In some embodiments, the reducing agent may be selected such that it is more readily oxidized compared to other components of the firefighting composition. As a non-limiting example, the reducing agent may be oxidized more readily than the sugar component or polysaccharide components. Illustrative reducing agents include, but are not limited to, sodium sulfite, sodium bisulfite, sodium metabisulfite, or a mixture of any two or more thereof.

The present firefighting compositions may advantageously be substantially free of any fluorinated compounds. As used herein, the “phrase substantially free of fluorinated compounds” means that the aqueous firefighting composition includes no more than 0.1 wt. % fluorinated compounds. In some embodiments, the firefighting composition includes no more than 0.01 wt. % and, in some instances, no more than about 0.005 wt. % fluorinated compounds. The firefighting compositions of the present disclosure may be substantially free of fluorine in any form. As used herein, the phrase “substantially free of fluorine” means that the firefighting composition has a total concentration of fluorine atoms on a weight percentage basis of no more than about 70 ppt F.

In another aspect, a method of fighting a fire includes applying any one of the firefighting compositions described herein to the fire. In some embodiments, the method may be used to completely extinguish the fire. Alternatively, in some embodiments, the method may be used to abate, or suppress, the fire for application of other agents or removal of a fuel source. In some embodiments, the fire may be a lithium-ion battery fire or a sodium-ion battery fire.

Additionally, provided herein are methods of controlling thermal runaway events associated with lithium-ion and/or sodium-ion batteries, the method including administering any one of the firefighting compositions described herein to a battery experiencing a thermal runaway event. In some embodiments, the fires may include those where the application of just water may cause further violent and exothermic reactions. For example, the fire may be a lithium-ion fire or a sodium-ion battery fire. As used herein, lithium-ion and sodium-ion batteries are those batteries that are rechargeable.

### EXAMPLES

The following examples more specifically illustrate formulations for preparing aqueous firefighting compositions according to various embodiments described above. These examples should in no way be construed as limiting the scope of the present technology.

### Example 1

Potassium formate (50 wt %) and high fructose corn syrup (50 wt %) were blended to form a firefighting composition. The firefighting composition may be applied to a lithium-based fire to extinguish or abate the fire.

While certain embodiments have been illustrated and described, it should be understood that changes and modifications can be made therein in accordance with ordinary skill in the art without departing from the technology in its broader aspects as defined in the following claims.

The embodiments, illustratively described herein may suitably be practiced in the absence of any element or elements, limitation or limitations, not specifically disclosed herein. Thus, for example, the terms “comprising,” “including,” “containing,” etc. shall be read expansively and without limitation. Additionally, the terms and expressions employed herein have been used as terms of description and not of limitation, and there is no intention in the use of such terms and expressions of excluding any equivalents of the features shown and described or portions thereof, but it is recognized that various modifications are possible within the scope of the claimed technology. Additionally, the phrase “consisting essentially of” will be understood to include those elements specifically recited and those additional elements that do not materially affect the basic and novel characteristics of the claimed technology. The phrase “consisting of” excludes any element not specified.

The present disclosure is not to be limited in terms of the particular embodiments described in this application. Many modifications and variations can be made without departing from its spirit and scope, as will be apparent to those skilled in the art. Functionally equivalent methods and compositions within the scope of the disclosure, in addition to those enumerated herein, will be apparent to those skilled in the art from the foregoing descriptions. Such modifications and variations are intended to fall within the scope of the appended claims. The present disclosure is to be limited only by the terms of the appended claims, along with the full scope of equivalents to which such claims are entitled. It is to be understood that this disclosure is not limited to particular methods, reagents, compounds, compositions, or biological systems, which can of course vary. It is also to be understood that the terminology used herein is for the purpose of describing particular embodiments only, and is not intended to be limiting.

In addition, where features or aspects of the disclosure are described in terms of Markush groups, those skilled in the art will recognize that the disclosure is also thereby described in terms of any individual member or subgroup of members of the Markush group.

As will be understood by one skilled in the art, for any and all purposes, particularly in terms of providing a written description, all ranges disclosed herein also encompass any and all possible subranges and combinations of subranges thereof. Any listed range can be easily recognized as sufficiently describing and enabling the same range being broken down into at least equal halves, thirds, quarters, fifths, tenths, etc. As a non-limiting example, each range discussed herein can be readily broken down into a lower third, middle third and upper third, etc. As will also be understood by one skilled in the art all language such as “up to,” “at least,” “greater than,” “less than,” and the like, include the number recited and refer to ranges which can be subsequently broken down into subranges as discussed above. Finally, as will be understood by one skilled in the art, a range includes each individual member.

All publications, patent applications, issued patents, and other documents referred to in this specification are herein incorporated by reference as if each individual publication, patent application, issued patent, or other document was specifically and individually indicated to be incorporated by reference in its entirety. Definitions that are contained in text incorporated by reference are excluded to the extent that they contradict definitions in this disclosure.

Other embodiments are set forth in the following claims.

1. A firefighting composition comprising:
a sugar component; and
a salt component comprising potassium formate hydrate, potassium formate, potassium acetate, magnesium sulfate, ammonium sulfate, sodium chloride, sodium sulfate, ammonium chloride, or a mixture of any two or more thereof.

2. The firefighting composition of claim 1, wherein the sugar component comprises a monosaccharide sugar, a disaccharide sugar, a sugar alcohol, or a mixture of any two or more thereof.

3. The firefighting composition of claim 1, wherein the sugar component comprises high fructose corn syrup, glucose, sucrose, or a mixture of any two or more thereof.

4. The firefighting composition of claim 1, wherein the sugar component comprises a carbonized or caramelized sugar.

5. The firefighting composition of claim 1 further comprising water.

6. The firefighting composition of claim 1 comprising from about 10 to about 90 wt % of the sugar component and from about 90 wt % to about 10 wt % of the salt component.

7. The firefighting composition of claim 1 comprising from about 30 to about 70 wt % of the sugar component and from about 70 wt % to about 30 wt % of the salt component.

8. The firefighting composition of claim 1 comprising about 50 wt % of the sugar component and about 50 wt % of the salt component.

9. The firefighting composition of claim 1, wherein the salt component comprises potassium formate hydrate or potassium formate.

10. A method of extinguishing or suppressing a fire, the method comprising administering a firefighting composition to the fire, the firefighting composition comprising:
a sugar component; and
a salt component comprising potassium formate hydrate, potassium formate, potassium acetate, magnesium sulfate, ammonium sulfate, sodium chloride, sodium sulfate, ammonium chloride, or a mixture of any two or more thereof.

11. The method of claim 10, wherein the fire is a lithium-ion battery fire or a sodium-ion battery fire.

12. The method of claim 10, wherein the sugar component comprises a monosaccharide sugar, a disaccharide sugar, a sugar alcohol, or a mixture of any two or more thereof.

13. (canceled)

14. The method of claim 10, wherein the sugar component comprises a carbonized or caramelized sugar.

15. The method of claim 10, wherein the composition further comprises water.

16. The method of claim 10, wherein the firefighting composition comprises from about 10 to about 90 wt % of the sugar component and from about 90 wt % to about 10 wt % of the salt component.

17. The method of claim 10, wherein the firefighting composition comprises from about 30 to about 70 wt % of the sugar component and from about 70 wt % to about 30 wt % of the salt component.

18. The method of claim 10, wherein the firefighting composition comprises about 50 wt % of the sugar component and about 50 wt % of the salt component.

19. A method of controlling a thermal runaway event associated with a lithium-ion or sodium-ion battery, method comprising administering a firefighting composition to a battery experiencing a thermal runaway event, the firefighting composition comprising:
a sugar component; and
a salt component comprising potassium formate hydrate, potassium formate, potassium acetate, magnesium sulfate, ammonium sulfate, sodium chloride, sodium sulfate, ammonium chloride, or a mixture of any two or more thereof.

20. The method of claim 19, wherein the sugar component comprises a monosaccharide sugar, a disaccharide sugar, a sugar alcohol, or a mixture of any two or more thereof.

21. (canceled)

22. The method of claim 19, wherein the firefighting composition further comprises water.
